(19) United States
(12) Patent Application Publication
(10) Pub. No.: US 2006/0212485 A1
(43) Pub. Date: Sep. 21, 2006

(54) Electronic file saving system

(75) Inventors: Yoshiko Suenaga, Kanagawa-ken (JP); Hiroki Miyachi, Kanagawa-ken (JP); Kouichi Mase, Chiba-ken (JP); Harunobu Maeda, Shizuoka-ken (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/245,921

(22) Filed: Oct. 6, 2005

(30) Foreign Application Priority Data
Mar. 17, 2005 (JP) 2005-077062

(51) Int. Cl. G06F 17/30

(52) U.S. Cl. 707/200

(57) ABSTRACT

It is an object of the invention to provide an electronic file saving system capable of classifying and organizing a wider variety of electronic files than before. The present invention relates to an electronic file saving system for storing an electronic file in any of a plurality of folders. The electronic file saving system includes: a processing rule storage portion for storing one or a plurality of processing rules each composed of a condition section and a processing content in association with each of all or part of the folders; a match processing rule search portion for, when the processing rules are stored for a destination folder into which an inputted electronic file is to be stored, judging whether or not an attribute of the inputted electronic file matches a condition described in the condition section of any of the processing rules; and an automatic processing means for processing the inputted electronic file in accordance with a description of the processing content of any of the processing rules whose condition described in the condition section is matched by the attribute of the inputted electronic file.

### BACKGROUND OF THE INVENTION

1. Field of the Invention

The present invention relates to an electronic file saving system, and more specifically to an electronic file saving system applicable to an electronic file storage device or system having hierarchical folders.

2. Description of Related Arts

Due to recent rapid spread of electronic files, such as electronic documents, at offices and households, there has been a growing need for classifying and saving electronic files. In such a case, leaving the user in change of the classification and saving through his or her manual operation is not advantageous in terms of operability. Thus, there have been already proposed technologies for automatically classifying and saving electronic files and the like.

For example, Japanese Patent Laid-Open No. 2000-112993 discloses the technology that analyzes a character attribute and an image attribute possessed by an electronic document, determines its classification, and then stores the electronic document in its corresponding document hierarchy (folder). In addition, for example, Japanese Patent Laid-Open No. 271692 (2003) discloses the technology that previously writes a paper document into images of a classification code and a script and then stores an electronic file obtained by photographing the paper document into a folder corresponding to the read classification code and script.

The conventional technologies described above involve determination into which folder an electronic file is to be saved; therefore, electronic files determined to be saved into the same folder are subject to the same processing. If a folder script indicating “those saved into the folder A are to be copied into the folder B” has been defined in association with the folder A, electronic files saved into the folder A are indiscriminatingly copied into the folder B.

However, different operations may be possibly required even for electronic files concerned with the same file.

### SUMMARY OF THE INVENTION

It is an object of the present invention to provide an electronic file saving system capable of classifying and saving a wider variety of electronic files than before.

According to one aspect of the present invention, an electronic file saving system for storing an electronic file in any of a plurality of folders includes: (1) processing rule storage means for storing one or a plurality of processing rules each composed of a condition section and a processing content in association with each of all or part of the folders; (2) match processing rule search means for, when the processing rules are stored for a destination folder into which an inputted electronic file is to be stored, judging whether or not an attribute of the inputted electronic file matches a condition described in the condition section of any of the processing rules; and (3) automatic processing means for processing the inputted electronic file in accordance with a description of the processing content of any of the processing rules whose condition described in the condition section is matched by the attribute of the inputted electronic file.

According to the electronic file saving system of the present invention, one or a plurality of processing rules each composed of a condition section and a processing content are stored in association with at least part of folders, so that, when an attribute of an electronic file inputted into any one of the folders matches a condition described in the condition section of the processing rules, processing whose processing content described in the processing rule is executed. Thus, even for electronic files to be stored into the same folder, processing varies depending on a difference in processing rules matched by these files, whether or not there is any processing rule matched, and the like, which permits classification and organization of a wider range of electronic files than before.

### BRIEF DESCRIPTION OF THE DRAWINGS

FIG. 1 is a block diagram showing the configuration of an electronic file saving system according to an embodiment of the present invention;

FIG. 2 is a block diagram showing the detailed configuration of an electronic file storage device according to the embodiment;

FIG. 3 is an explanatory diagram of a folder hierarchy structure according to the embodiment;

FIG. 4 is an explanatory diagram of a processing rule according to the embodiment;

FIG. 5 is a flowchart showing an operation of setting a processing rule according to the embodiment; and

FIG. 6 is a flowchart showing an operation of storing an electronic file according to the embodiment.

### DETAILED DESCRIPTION OF THE PREFERRED EMBODIMENTS

(A) One embodiment

One embodiment of an electronic file saving system according to the present invention will be described with reference to the accompanying drawings. FIG. 1 is a block diagram showing the configuration of the electronic file saving system according to this embodiment.

In FIG. 1, an electronic file saving system 1 has an electronic file storage device 3, a multifunction processor (i.e., composite document processing device, hereinafter abbreviated as MFP) 4, a personal computer 5, a Web server 6, a gateway device 7, and the like, all connected to one another via a LAN 2. The LAN 2 is connectable to another network (for example, an IP network) 8, via the gateway device 7.

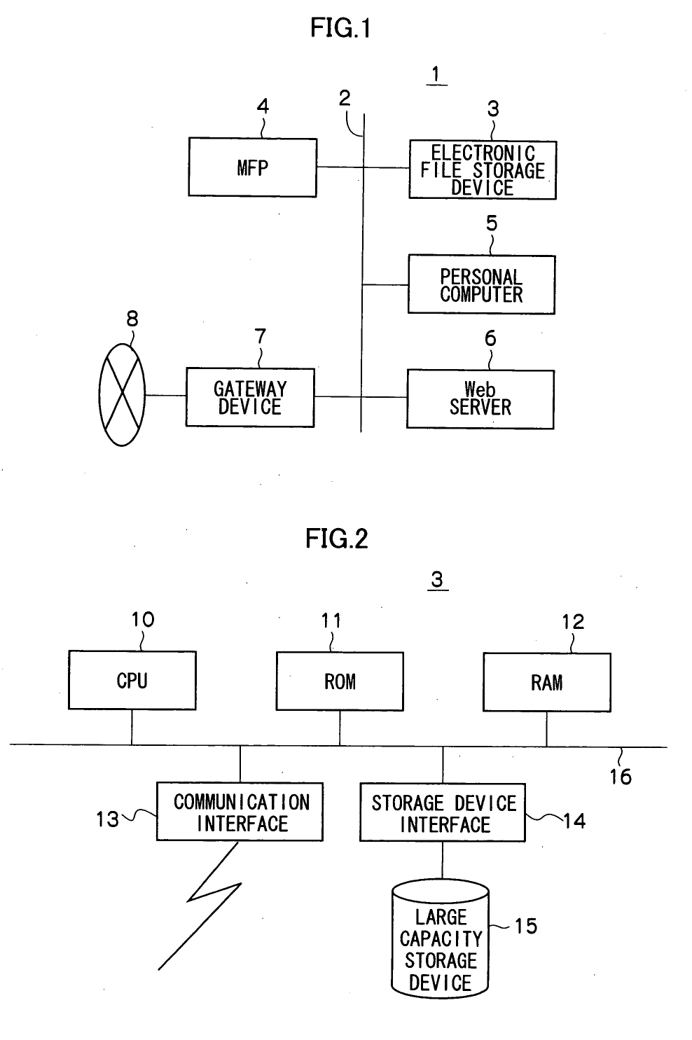

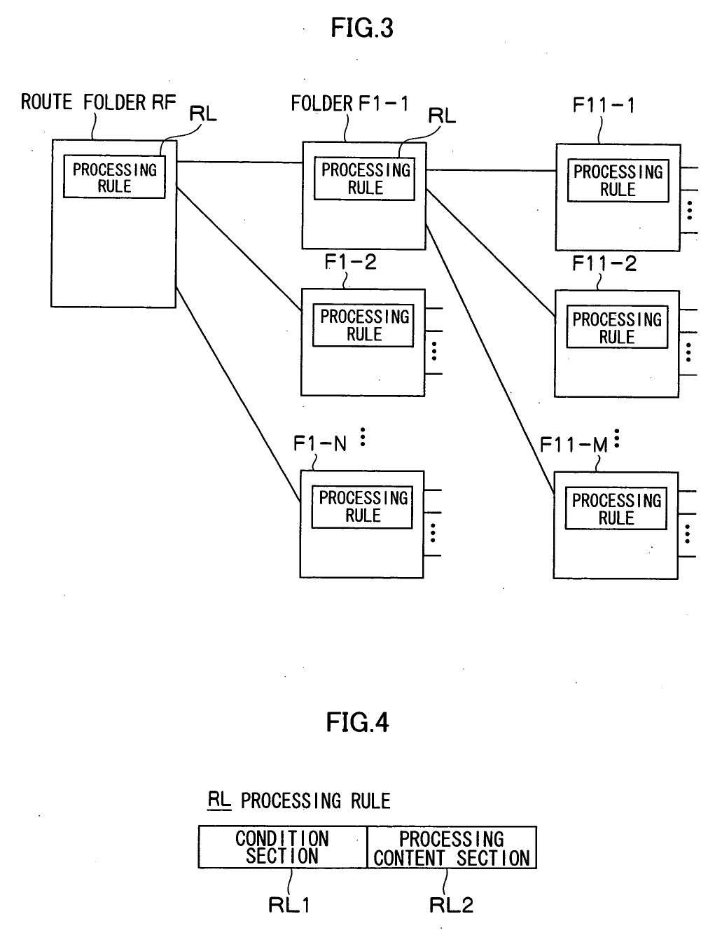

The electronic file storage device 3 stores electric files (image files, sound files, text files and any other types of files) provided from the MFP 4, the personal computer 5, the Web server 6, the gateway device 7, and the like (in this case, the original transmitter is another network 8). The electronic file storage device 3 also retrieves stored electronic files that have been requested by the MFP 4, the personal computer 5, the Web server 6, the gateway device 7, and the like (in this case, the original requester is another network 8) and then provides the retrieved electronic files to the original requester or the like. The detailed configuration of the electronic file storage device 3 is as shown in FIG. 2.

In FIG. 2, the electronic file storage device 3 has a CPU 10, a ROM 11, a RAM 12, a communication interface (i.e., LAN interface) 13, a storage device interface 14, and a large capacity storage device 15 (for example, an HDD). The CPU 10, the ROM 11, the RAM 12, the communication interface 13, and the storage device interface 14 are connected to one another via a system bus 16. The large capacity storage device 15 is connected to the storage device interface 14. The communication interface 13 serves as an interface to the LAN 2. The electronic file storage device 3 shown in FIG. 2 includes no input portion such as a keyboard and no output portion such as a display. However, the electronic file storage device 3 may include an input portion and an output portion.

The CPU 10 executes file management programs dispersed and stored separately in the ROM 11, the RAM 12, the large capacity storage device 15, and the like, stores, into the large capacity storage device 15, an electronic file that comes in via the communication interface 13, and retrieves, from the large capacity storage device 15, an electronic file requested from outside via the communication interface 13 and then transmits the retrieved electronic file to the outside via the communication interface 13. In this case, an electronic file has as attributes, for example, the file name, the file size, the file creation date, the file update date, the file creator (user name or machine name), the file extension, and the like.

In this embodiment, electronic files are respectively adapted to be managed by hierarchical folders RF, F1-1 to F1-N, F11-1 to F11-M, and so on (the term “folder” here is synonymous with a term “directory”). There may also be included a folder that defines another device, such as the multifunction processor 4, the personal computer 5, the Web server 6, or the like. When the electronic file storage device 3 has, in addition to the large capacity storage device 15, hardware such as a 3,5-inch flexible disc drive, there may be included a folder that defines such hardware. In the description below, however, another device and hardware are not included in the concept of the folder.

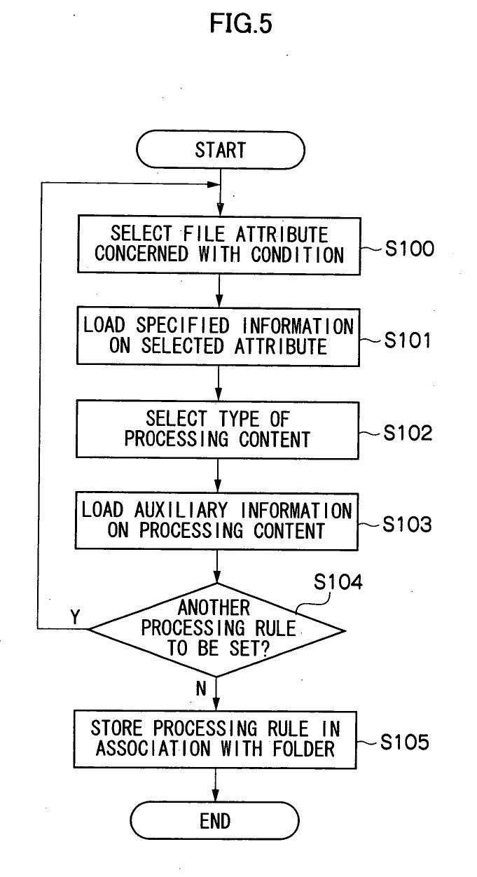

All or part of the folders each includes a description of a processing rule RL for an electronic file that has been inputted thereinto. The number of processing rule RL provided for one folder is not limited to one, and thus may be two or more. The processing rule RL consists of a condition section RL1 and a processing content section RL2, as shown in FIG. 4.

The condition section RL1 includes a description of a condition to which the processing rule RL applies. In this embodiment, a condition is described concerning an attribute of an electronic file. Examples of a condition include: (1) an electronic file whose file name includes the specified character string is judged to match the condition; (2) an electronic file whose creation date and time is in the specified range is judged to match the condition; (3) an electronic file whose creator is the specified creator is judged to match the condition; (4) an electronic file whose file size is in the specified range is judged to match the condition; (5) an electronic file whose extension is the specified one is judged to match the condition; and (6) an electronic file whose creation date and time is in the specified range is judged to match the condition. The examples described above refer to a case where one file attribute is concerned with a condition, but a condition may be defined by two or more file attributes. For example, an electronic file whose file name includes the specified character string and also whose creation date and time is in the specified range is judged to match the condition.

The processing content section RL2 describes how to process an electronic file that matches a condition described in the condition section RL1. An electronic file that does not match a condition is stored into its corresponding folder. Examples of processing contents include: (1) the electronic file is transferred to the specified folder; (2) the electronic file is copied into the specified folder; (3) the electronic file is transmitted to the specified destination, where the destination is the MFP 4, another electronic file storage device, an information processor defined by a mail address, or the like; (4) the electronic file is converted into the specified format and then stored; (5) the electronic file is to be provided with additional search information; and (6) the electronic file is converted into the specified format through OCR (i.e., character recognition) and then stored.

A folder hierarchy structure and a processing rule, and the like can be set and edited only by, for example, a system manager. If the electronic file storage device 3 has an input portion and an output portion, the system manager can perform the setting and editing operations by use of the input portion and the output portion, so that a corresponding program of the electronic file storage device 3 executes setting and editing processing in accordance with the aforementioned operations. If the electronic file storage device 3 has no input portion and no output portion, the system manager performs, on the personal computer 5, operations of setting and editing a folder hierarchy structure, a processing rule, and the like, so that corresponding programs of the electronic file storage device 3 and the personal computer 5 cooperatively execute setting and editing processing in accordance with the aforementioned operations.

The operations of setting and editing a folder hierarchy structure are identical to the conventional operations, and thus are omitted from the description.

The operation of setting a processing rule will be described below with reference to a flowchart of FIG. 5. When the operation of setting a processing rule is performed cooperatively by the electronic file storage device 3 and the personal computer 5, the processing shown in FIG. 5 is also performed cooperatively by the electronic file storage device 3 and the personal computer 5. The description below is based on the assumption that the operation is achieved by such cooperative performance.

For example, when the operations of setting and editing a folder hierarchy structure are completed, a display of the personal computer 5 displays a message asking whether or not to perform an operation of setting a processing rule or the like for a newly set folder, an added folder, a modified folder, a folder connected in a tree-like manner to the added or the modified folder, or the like. If the system manager directs through the keyboard that the processing rule setting be performed, the electronic file storage device 3 and the personal computer 5 start the processing shown in FIG. 5. Irrespectively of the operations of setting and editing a folder hierarchy structure, the processing shown in FIG. 5 may be started in response to directions given by the system manager. In this case, before or after the processing shown in FIG. 5 is performed, an operation is executed for specifying a folder to which the set processing rule applies.

When the processing shown in FIG. 5 starts, the display displays a screen for selecting the file attribute that defines the condition, prompting the system manager to select the file attribute (S100). The selection is made from among, for example, the file name, the file size, the file creation date, the file update date, the file creator (user name or machine name), and the file extension. At this point, if two or more file attributes are permitted for the condition, two or more file attributes may be selected. Moreover, the relationship between these attributes may be specified (with OR or AND).

Subsequently, the display displays a screen including an input field for inputting the condition content for the selected file attributes, and then the inputted condition content is loaded (S101). For example, if the file name is selected as the file attribute, the display displays an input field for inputting the character string included in the file name that matches the condition, prompting the system manager to input a desired character string. For example, if the file creation date is selected as the file attribute, the system manager is prompted to input the range for the creation date that is judged to match the condition.

In the flowchart of FIG. 5, specified information is loaded in order of the file attribute and the condition content. Alternatively, the display may display a screen that permits selecting the file attribute and inputting the condition content simultaneously so that the selected file attribute and the inputted condition content are loaded simultaneously.

Subsequently, the display displays a screen for selecting the type of a processing content, prompting the system manager to select the type of a processing content (S102). Types of processing contents include, for example, “Transfer”, “Copy”, “Transmission to the specified destination”, “Format conversion”, “Addition of search information”, and “Character recognition”.

Next, the display displays a screen for loading auxiliary information corresponding to the selected type of a processing content so as to load the aforementioned auxiliary information (S103). For example, in the case of “Transfer”, the destination folder (folder name) is loaded. For example, in the case of “Addition of search information”, the search information itself is loaded. For example, if the number of format types of an electronic file that has undergone “character recognition” is one (if format definition is not required), the step for loading auxiliary information (S103) can be omitted when “Character recognition” is selected.

In the flowchart of FIG. 5, specified information is loaded in order of the type of a processing content and the auxiliary information. Alternatively, the display may display a screen that permits selecting the type of a processing content and inputting the auxiliary information simultaneously so that the selected type of a processing content and the inputted auxiliary information are loaded simultaneously.

Subsequently, the display displays a message asking whether or not to set another processing rule so as to confirm with the system manager whether or not to set another processing rule (S104). If another processing rule is to be set, the processing goes back to step S100 described above. If another processing rule is not to be set, the set processing rule is stored in association with its corresponding folder (S105), and a series of setting processing ends.

Operations for modifying and deleting a processing rule are identical to operations for modifying and deleting various data, and the modification operation is based on the setting operation; therefore, these operations are omitted from the description.

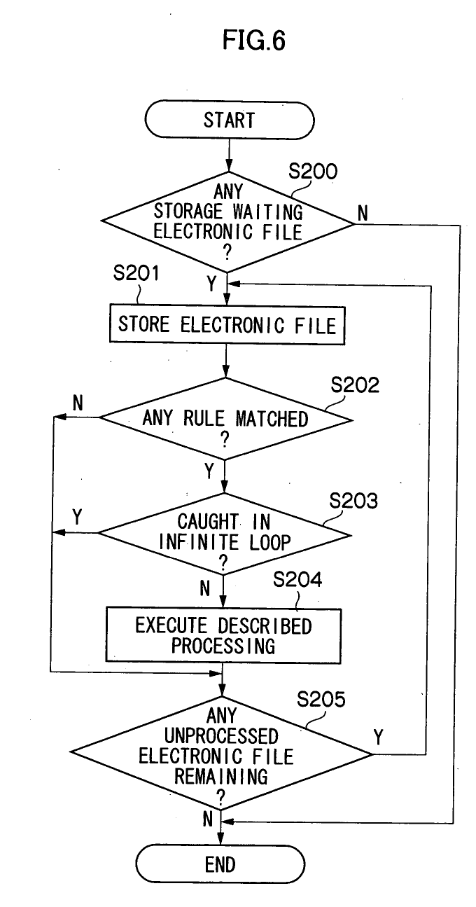

Next, with reference to a flowchart of FIG. 6, a description will be given on an operation of storing an electronic file that is performed by the electronic file storage device 3.

The (CPU 10 of the) electronic file storage device 3 starts the processing shown in FIG. 6 at, for example, every predetermined cycle, and judges whether or not any storage waiting electronic file exists in a storage waiting buffer that is set on, for example, the RAM 12 (S200). If no storage waiting electronic file exists, a series of processing shown in FIG. 6 ends immediately.

If any storage waiting electronic file exists, the leading electronic file is stored into its corresponding folder (S201).

Subsequently, the (CPU 10 of the) electronic file storage device 3 judges whether or not the stored electronic file matches any of processing rules set for the aforementioned folder (S202). If the stored electronic file matches none of the processing rules, the processing proceeds to step S205 to be described below.

By contrast, if the stored electronic file matches any of the processing rules, after confirming that the processing is not caught in an infinite loop (S203), the electronic file storage device 3 executes processing whose content is defined by this processing rule (S204).

For example, when there are set a processing rule such that the folder A is transferred to the folder B and a processing rule such that the folder B is transferred to the folder A, if a certain electronic file meets both of the processing rules, the processing goes into an infinite loop. This infinite loop processing can be terminated by time management; however, the step S203 described above is provided to terminate this processing by prioritizing the processing rule for the higher-level folder over the one for the lower-level folder which thus serves as a transfer destination.

If the stored electronic file matches none of the processing rules, or when the processing whose content is defined by the processing rule the stored electronic file matches is executed, the electronic file storage device 3 judges whether or not there is any storage waiting electronic file remaining in the storage waiting buffer (S205). If there is any storage waiting electronic file remaining, the processing goes back to step S201. If there is no storage waiting electronic file remaining, the series of processing shown in FIG. 6 ends.

For example, assume that two processing rules RL1 and RL2 below are provided for a folder “Capture”.

The processing rule RL1 defines that a file whose file name includes “Budget” is transferred to a folder “Budget”.

The processing rule RL2 defines that a file whose file name includes “Weekly Report” is copied into a folder “Weekly Report”.

In such a condition, an electronic file which comes into the folder “Capture” and whose file name is “Budget04B” is automatically transferred to the folder “Budget”. An electronic file which comes into the folder “Capture” and whose file name is “WeeklyReport0409” is automatically copied into the folder “Weekly Report”. Meanwhile, an electronic file which comes into the folder “Capture” and whose file name is “Agenda0409” is not processed, and thus directly stored into the folder “Capture”.

According to the electronic file saving system 1 of the embodiment described above, upon registration of an electronic file into the electronic file storage device, the user or the like is only required to input the electronic file into a predetermined folder without specifically judging into which folder the electronic file is to be saved, whereby thereafter the electronic file is automatically classified, organized, and processed in accordance with a predetermined procedure.

In this embodiment, even electronic files to be stored into the same folder can be classified and organized in different manners by applying a processing rule.

(B) Another embodiment

The above embodiment has been described, referring to various modified embodiments. There is a further modified embodiment as illustrated below.

In the embodiment described above, folders are indicated in the tree-like hierarchy structure. However, the present invention is also applicable to a case where there is no structural hierarchy among folders.

Moreover, a folder corresponding to a receive buffer or a reception box may be provided, together with various processing rules provided therefor, thereby permitting classification of different types.

Folders of the present invention are not necessarily provided in the same device, but may be dispersed over different devices. That is, the electronic file saving system of the invention may be composed of one device or a plurality of devices. In the latter case, all or part of the devices may have, as a major junction, a function other than the electronic file storage function.

In the embodiments described above, one processing content is provided for one condition; however, a processing rule may include a plurality of processing contents for one condition.

What is claimed is:

1. An electronic file saving system for storing an electronic file in any of a plurality of folders, the electronic file saving system comprising:
processing rule storage means for storing one or a plurality of processing rules each composed of a condition section and a processing content in association with each of all or part of the folders;
match processing rule search means for, when the processing rules are stored for a destination folder into which an inputted electronic file is to be stored, judging whether or not an attribute of the inputted electronic file matches a condition described in the condition section of any of the processing rules; and
automatic processing means for processing the inputted electronic file in accordance with a description of the processing content of any of the processing rules whose condition described in the condition section is matched by the attribute of the inputted electronic file.

2. The electronic file saving system according to claim 1, further comprising an operation input portion and processing rule registration means for loading a processing rule inputted through an input operation and storing the inputted processing rule into the processing rule storage means.

3. The electronic file saving system according to claim 1, further comprising infinite loop processing avoidance means for avoiding infinite loop processing in a case where the processing performed by the automatic processing means on the electronic file inputted into the destination folder is either one of transfer and copy processing that involves inputting the electronic file into another folder and where a processing rule stored for said another folder is either one of transfer and copy processing that involves inputting the electronic file into said destination folder.

4. The electronic file saving system according to claim 1,
wherein the infinite loop processing avoidance means prioritizes the processing rule of either one of said destination folder and said another folder, whichever is located at a higher level in a folder hierarchy structure.
